(19) United States
(12) Patent Application Publication
(10) Pub. No.: US 2026/0369793 A1
(43) Pub. Date: Nov. 19, 2026

(54) Energy Storage System And Method For Manufacturing An Energy Storage System

(71) Applicant: Lisa Dräxlmaier GmbH, Vilsbiburg (DE)

(72) Inventors: Michael Römelsberger, Niedertaufkirchen (DE); Robert Magunia, Geisenhausen (DE)

(73) Assignee: Lisa Dräxlmaier GmbH, Vilsbiburg (DE)

(21) Appl. No.: 19/754,437

(22) Filed: Jul. 27, 2026

Related U.S. Application Data
(62) Division of application No. 17/637,490, filed on Feb. 23, 2022.

(30) Foreign Application Priority Data
Aug. 26, 2019 (DE) 102019122804.2

(51) Int. Cl. H01M 50/284; B60L 53/16; H01M 10/42; H01M 50/249; H01M 50/296; H01M 50/507

(52) U.S. Cl. CPC H01M 50/284; B60L 53/16; H01M 10/425; H01M 50/249; H01M 50/296; H01M 50/507; H01M 2010/4271; H01M 2220/20

(57) ABSTRACT

The invention relates to a method for manufacturing an energy storage system and an energy storage system with at least one module for accommodating a plurality of electrochemical cells, wherein the module is at least partially enclosed by a housing, wherein the housing has at least one bearing device on opposite sides oriented towards the module, wherein the module is arranged in an end position spaced apart from the bearing device, wherein in the end position a force is transmitted from the bearing device to the module by means of a contact element to the module by means of a contact element, and wherein, in the end position, the contact element is fixed in position with respect to the housing and the module. This provides a technical teaching that allows an energy storage system to be manufactured more easily and provides a reliable arrangement of at least one module in an energy storage system.

### CROSS REFERENCE TO RELATED APPLICATIONS

This application is a divisional patent application of U.S. patent application Ser. No. 17/637,490, filed Feb. 23, 2022, which is a national phase of international patent application PCT/EP2020/073637, filed 24 Aug. 2020 and which claims priority to German patent application DE 102019122804.2, the content of all of the aforementioned being herein incorporated by reference.

### BACKGROUND OF THE INVENTION

### Field of the Invention

The invention relates to the field of energy storage systems, in particular electrochemical energy storage systems, and concerns a method for manufacturing an energy storage system.

### Description of Related Art

Energy storage systems for the electric drive of vehicles are typically electrochemical energy storage devices comprising a plurality of electrochemical cells depending on the desired output voltage. In the field of electric drives for motor vehicles, energy storage systems operate with an output voltage of 60V and higher, in particular up to 2 kV, depending on the selected drive concept and the minimum motor and maximum generator voltages that occur. In this context, they are also referred to as high-voltage batteries.

Depending on the area of application, energy storage systems are sometimes subject to high load cycles, both in terms of power demand and energy recovery. For this reason, effective cooling is required for the electrochemical cells, such as battery cells, of the energy storage system. This can be achieved in various ways. Liquid-cooled energy storage systems are particularly suitable.

For cooling to be efficient, it is essential that there is effective heat exchange between the heat-generating components and the heat-dissipating components.

In order to provide appropriate paths for heat dissipation from the modules to the cooling system, precise positioning of the module within the housing is required.

Both the properties of the module's interface designed for heat conduction and the properties of the housing's interface designed for heat conduction play a role here. Furthermore, both the mounting of the module within the housing and the tolerances for the module dimensions are important. Due to deviations, in particular manufacturing deviations, and deformation of components, a comparatively high tolerance margin must be provided to compensate for these inaccuracies and deformations. This requires time-consuming measurements of the respective conditions for the respective module in the housing, which considerably reduces production throughput. Furthermore, due to the correspondingly high tolerances, it may be necessary to use more consumables, e.g., filling material, which is disadvantageous in terms of cost. The invention aims to achieve an improvement in this regard.

### BRIEF SUMMARY OF THE INVENTION

A task of the invention is therefore to provide an energy storage system that is easier to manufacture and provides a reliable arrangement of at least one module in an energy storage system, as well as to provide a corresponding manufacturing method for an energy storage system.

The task is solved by the subject matter of the independent claim. Advantageous further developments of the invention are specified in the dependent claims, the description, and the accompanying figures.

An energy storage system according to the invention comprises at least one module for accommodating a plurality of electrochemical cells. The module is at least partially enclosed by a housing. At least one bearing device for securing the module is provided on opposite sides of the housing facing the module. Furthermore, the module is arranged in an end position spaced apart from the bearing device. In the end position of the module, a force can be transmitted from the bearing device to the module by means of a contact element, whereby in the end position the contact element is fixed in position with the housing and the module, i.e., they cannot perform any relative movement with respect to each other without destroying the fixation.

The module can be positioned in the end position by means of a guide device. The guide device ensures that the module is positioned within the housing within the permissible tolerance. In particular, the module can be positioned within the housing in such a way that the bearing device is spaced apart in a desired position and orientation relative to the contact element.

The guide means can be designed as a separate device for positioning the module, which positions a module or the modules in a desired position relative to the bearing devices, e.g., in the form of an assembly device with position and/or orientation control for the module to be assembled. For this purpose, a corresponding measurement, in particular of the coordinates of the bearing device, can be carried out in a plane parallel to the base plate.

The guide means may also be designed as a separate component that interacts with the module and the housing. This may also be enclosed by the module or the housing. The guide means must be designed in such a way that it allows the module to move relative to the housing and guides the module to a predetermined end position.

By spacing the end position of the module from the bearing device, manufacturing inaccuracies of the module and the bearing device are eliminated, as these can be flexibly compensated for by a contact element. This allows the tolerances to be reduced in order to compensate for corresponding inaccuracies. In particular, for example, a gap or layer thickness between the bottom of the module and a bottom plate of the housing can be reduced. This is particularly advantageous when modules of the energy storage system need to be replaced or exchanged, as the invention allows for simple, safe, and accurate positioning of the module in the housing, even in the context of repairs or module replacement.

The housing may be designed in several parts. It serves in particular to secure the module by means of the bearing device. In particular, it can interact with the guide means when guiding the module so that a desired end position of the module can be set. In particular, the housing can, for example, have a shape or structure, in particular a groove, which together with the module, for example with a pin arranged on the module and engaging in the groove, provides a guide. The housing for a module can be designed as a partition between the respective modules and can, for example, also be part of the housing of the outer housing of the energy storage system.

The spacing of the module from the bearing device in the end position means that the module does not directly contact the bearing device. The remaining distance is bridged by the contact element, which is movable relative to the module. The module may have a section that is arranged vertically above the bearing device.

As long as the module is not in the end position, the contact element can be designed to be movable relative to the module. Thus, for example, by moving the contact element in the direction of the bearing device, a contact can take over a bridging function with regard to the existing distance after the module has been positioned on a housing base. Once the contact element is in contact with the bearing device, it is fixed to the module and housing. This position of the module relative to the fixed contact element and the housing is referred to as the end position.

After being positioned on the bearing device, the contact element is firmly connected or fixed to the module and the housing, for example by gluing, welding, or by means of another, possibly detachable, fastening method. It is essential that the contact element, the module, and the housing are fixed relative to each other, whereby in this arrangement the contact element can transmit a force between the bearing device and the module. The contact element can be made of metal in particular.

The design of the contact element for transmitting force from the bearing device to the module, in particular in the guide direction, allows a hard connection, for example in the case of a screw connection or clamp, a hard screw connection or hard clamp, to be realized. The contact element can therefore transmit a corresponding counterforce between the bearing device and the module.

The number of bearing devices can, in particular, be equal to the number of contact elements. A plurality of contact elements, in particular four contact elements, can be provided in order to fix the module in the housing to a respective associated bearing device. The contact elements can be aligned with the associated bearing device, i.e., the virtual extension of the contact element penetrates the bearing device.

The energy storage device may comprise a plurality of modules, each module being positionable in accordance with the invention. In particular, each module may be wholly or partially enclosed by a housing, so that corresponding bearing devices may be provided on the side wall of the housing.

Any battery cells suitable for the application can be used as electrochemical cells, especially for high-voltage applications.

In an exemplary design of the energy storage system, the contact element is designed as a sleeve, in particular one enclosed by the module. The module may have a continuous borehole in which a sleeve is arranged as a contact element. Furthermore, the guide means may comprise the sleeve. The guide means and the housing may be matched in shape in such a way that the module is guided into a desired end position, in particular relative to the bearing device, by interaction with the housing or a housing wall. The at least one guide means can, for example, be designed as a protruding guide element, in particular a cylindrical or semi-cylindrical guide element. This can have a bore within which the sleeve is arranged. This can, for example, be provided instead of one or more vertical edges of the module. However, it can also be arranged at a position between two vertical edges of the module. In this form, for example, the contact element and the guide means can be combined by means of a structure of the module. However, the guide means and the contact element can also be arranged spatially separated.

A sleeve or contact element with a hollow cylindrical shape is a particularly simple design for a contact element that can be moved relative to the module. Furthermore, such a contact element allows the bearing device to be connected to the module through the hollow space of the sleeve. In one possible design, the module and the bearing device are additionally fixed to each other in the end position by means of a fastening element guided through the sleeve.

In a further development of the energy storage system, the sleeve has a shelter in its axial direction over a module boundary in the direction of the bearing device, wherein the bearing device is designed as a screw-on tab and the shelter is supported on the screw-on tab, and the module and the screw-on tab are fastened to each other by means of a screw guided through the sleeve. The shelter is defined as the part of the sleeve that protrudes from the module in the direction of the bearing device. This shelter bridges the gap between the screw-on tab and the module and allows force to be transmitted in the axial direction of the sleeve between the screw-on tab and the module. This is designed as a counterforce to the force of the screw, which connects the module to the screw-on tab along the sleeve.

In a possible further development of the energy storage system, a layer of a paste-like, heat-conducting material is arranged between a bottom of the module and a bottom plate of the housing, on which the module bottom is essentially supported over its entire surface, wherein the bottom plate has at least one cooling channel in the area of the layer, preferably below the module bottom, into which heat emitted by the module can be dissipated. Such a layer of paste-like, heat-conducting material can be applied to the housing base in such a way that the module base is in almost complete contact with the paste-like, heat-conducting material when it is arranged in the housing. So-called gap fillers, which consist in particular of cross-linked silicone-based elastomers, such as the gap filler with the brand name BERGQUIST GAP FILLER TGF 3600 from Henkel AG & Co. KGaA, are particularly suitable as paste-like, heat-conducting materials. However, silicone-free gap fillers are now also available. Alternatively, the paste-like, thermally conductive material can also be applied to the module base and pressed onto the base plate of the housing. The material can be applied using a wide slot nozzle or a round nozzle, for example.

The paste-like, heat-conducting material, e.g., a thermal paste or adhesive, with a thermal conductivity coefficient in the range of 1.0 to 6.0 W/mK, in particular 1.0 to 3.5 W/mK, in particular 1.5 to 3.5 W/mK, in particular 1.0 to 2.5 W/mK, heat transfer from the module to the cooling channel is improved. The thermal conductivity coefficient can be selected depending on the layer thickness to be set. By eliminating manufacturing deviations of the module and the bearing device, in particular the distance of the bearing device from the module in the direction of displacement of the contact element, by means of the jig shown, the layer thickness of the paste-like, thermally conductive material can be significantly reduced. This is because the aforementioned manufacturing inaccuracies do not have to be compensated for by the thickness of the paste-like, heat-conducting material. This means that material savings of up to 50% or more can be achieved for the paste-like, heat-conducting material. Thickness is understood to mean the average thickness of the layer, which usually varies only slightly from this value. In this consideration of the average thickness of the layer, only sections between the module and the housing in which a layer is also present should be taken into account.

Alternatively or in addition to a reduced layer thickness of the paste-like, heat-conducting material, a more cost-effective material with a lower thermal conductivity coefficient can also be used. In a possible further development, the paste-like, heat-conducting material has a thickness of 0.2 mm to 2.5 mm. The more precisely the housing is manufactured from module to module, the lower the layer thickness can be selected. Furthermore, at this thickness, the paste-like, heat-conducting material can have a thermal conductivity coefficient within a range of 1.0 W/mK to 3.5 W/mK, in particular in the range of 1.0 W/mK to 2.0 W/mK or 1.0 W/mK to 2.5 W/mK. In a further possible embodiment, the paste-like, thermally conductive material has a layer thickness of 0.25 mm to 1.0 mm with a thermal conductivity coefficient in the range of 1.0 W/mK to 1.75 W/mK.

The task is also solved by a method for manufacturing an energy storage system with at least one module for accommodating a plurality of electrochemical cells. A pasty heat-conducting material, in particular as a layer and/or a bead, is applied to a base plate and/or the module base, which is enclosed by a housing. During the process of arranging the module, the module is guided relative to the housing in such a way that at least one contact element enclosed by the module, in particular a sleeve, is aligned in its axial direction with at least one bearing device for the module arranged on the housing. During or after completion of the module positioning process, the at least one contact element is displaced in the axial direction relative to the module in such a way that it contacts the aligned bearing device. After the at least one contact element is in contact with the bearing device, the at least one contact element is fixed relative to the housing and the module in this end position, in particular by means of a non-detachable connection. Furthermore, the module is fixed to the bearing device or devices by means of fastening means.

Such a method can be used to manufacture an energy storage module that requires a low layer thickness of pasty, heat-conducting material and allows for an inexpensive and simple arrangement of the module in a housing.

The contact element can be fixed to the housing and to the module in a single fixing step or in separate steps. If necessary, different fixing means can be used to fix the contact element to the housing and the contact element to the module. The paste-like heat-conducting material can be applied as a layer or as a bead. In the final position, this should form a layer between the base slat and the module base, at least in sections, in order to dissipate heat from the module. In one embodiment, the layer can be arranged over the entire area between the entire module base and the base plate.

In a further development of the manufacturing process, the module is positioned on the layer by means of a calotte during the process of arranging the module on the base plate. The use of a calotte ensures that the force is distributed evenly across the surface during the process of arranging the module on the base plate of the housing. Any wedging between the bottom of the module and the base plate of the housing is compensated for by orienting the module according to the inclination of the base plate as soon as the base plate exerts a force on the module at a point on the module base. The e attachment of the module to a calotte results in a rotational movement of the module and an essentially parallel arrangement of the module base on the base plate.

In a further refinement of the manufacturing process, in particular after completion of the arrangement process and positioning of the sleeve on the bearing device, the module is welded to the sleeve and the module is screwed to a bearing device designed as a screw-on tab by means of a screw guided through the sleeve. The sleeve can also be welded to the housing. Welding allows for secure and quick fixation, which enables a corresponding throughput in the manufacture of an energy storage device. This is particularly important if the energy storage device is made up of a large number of modules, e.g., 30 modules or more.

### BRIEF DESCRIPTION OF THE SEVERAL VIEWS OF THE DRAWINGS

Further advantages features and details of the various embodiments of this disclosure will become apparent from the ensuing description of a preferred exemplary embodiment and with the aid of the drawings. The features and combinations of features recited below in the description, as well as the features and feature combination shown after that in the drawing description or in the drawings alone, may be used not only in the particular combination recited, but also in other combinations on their own, without departing from the scope of the disclosure.

The present invention is described in more detail below with reference to examples of embodiments and the figures, wherein:

FIG. 1 depicts a schematic cross-sectional view through an embodiment of an energy storage system according to the invention with a module in the end position,

FIG. 2 depicts a schematic cross-sectional view through an embodiment of an energy storage system according to the invention with a module during the process of arranging the module in the housing, and

FIG. 3 depicts a flow chart for the schematic representation of an exemplary sequence of a manufacturing process according to the invention.

### DETAILED DESCRIPTION OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B, or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that “at least one of “A, B, and C” should be understood as including only one of A, only one of B, only one of C, or any combination of A, B, and C.

The figures are merely schematic representations and serve only to explain the invention. Identical or similarly functioning elements are designated by the same reference symbols throughout.

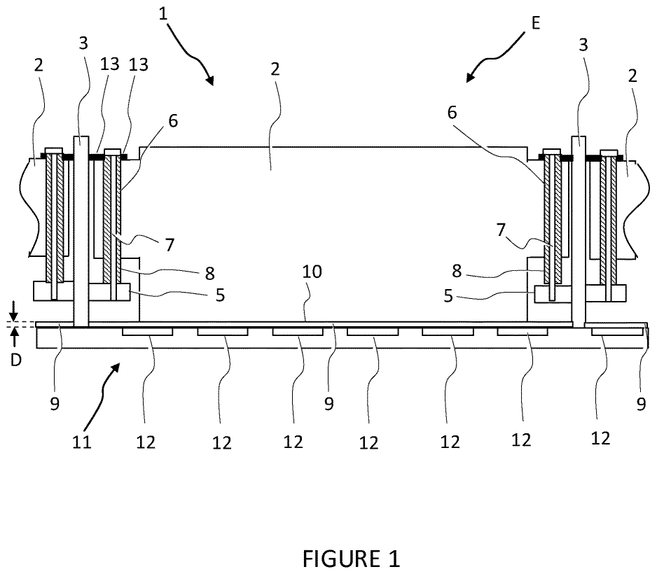

FIG. 1 shows a schematic cross-sectional view of an extract from an energy storage system 1 with three adjacent modules 2. These each have a plurality of electrochemical cells, which are not shown. The modules 2 are separated from each other by a housing 3. The modules 2 shown adjacent to the module 2 shown in the center are only indicated schematically. The energy storage system 1 can comprise a plurality of modules 2. The module 2 is preferably designed to be axially symmetrical with respect to its main central axes, i.e., the axes that run through the center of the module and are perpendicular to the boundary surfaces of the module 2.

Module 2 has, for example, four contact elements 6 in the form of metal sleeves, which are shown hatched in FIG. 1 for clarification. These sleeves 6 are arranged in four corresponding bores of module 2 in corners of module 2 and extend parallel to a side wall of housing 3. More or fewer contact elements 6 may also be provided, e.g., two. An inner radius of the borehole of the module 2 essentially corresponds to the outer radius of the sleeve 6, whereby the dimensioning ensures, on the one hand, that the sleeve 6 is movable relative to the module 2 during the insertion of the module 2 into the housing 3 by a pressure or pushing force in the longitudinal direction of the sleeve 6 relative to the module 2, but on the other hand is held in the bore when no force is applied to sleeve 6.

In the end position E, the opening of the sleeve 6 should be aligned with an opening of a bearing device 5 provided on the housing 3. The bearing device 5 is designed as a screw-on tab 5. The center longitudinal axis of the sleeve 6 and the center longitudinal axis of the screw hole of the screw-on tab 5 are essentially congruent in the end position E. The screw-on tab 5 extends from a side wall of the housing 3 facing the module 2, essentially parallel to a base plate 11 of the housing 3 in the direction of the module 2. The number of screw-on tabs 5 corresponds to the number of sleeves 6.

Module 2 is guided relative to the housing by means of a guide device 4. In the embodiment, this guide device 4 is designed as an automatic placement machine, by means of which the respective module 2 can be positioned at a specified position in the housing 3, in particular relative to the screw-on tabs 5. For this purpose, the respective position and/or location of the screw-on tab 5 in the housing 3 can be measured in advance and made available to a control and/or regulation system for the positioning process of the module 2. This then positions module 2 at a corresponding target position, for example in such a way that a longitudinal center axis of sleeve 6 is aligned with the center axis of the opening of a screw-on tab 5.

Module 2 is positioned free-standing, i.e., the walls of module 2 that face the housing walls, in particular perpendicular to the module base 10, do not contact the corresponding housing walls. This is particularly advantageous with regard to thermal expansion of module 2.

Alternatively, physical guide means may also be provided. For example, instead of the vertical edges of module 2, cylindrical elements may be provided in these edge areas, in which the bore for the sleeves 6 and the sleeves 6 are arranged. The cylindrical elements engage in a recess or extension of the housing 3 provided for this purpose, whereby the module 2 can be guided in such a way that the sleeves 6 can be positioned above the screw-on tabs 5 in alignment with them. This is not shown in FIG. 1.

In the end position E, the module 2 is mounted on a base plate 11 of the housing 3. A paste-like, heat-conducting material is applied between a module base 10 and the base plate 11 of the housing. In the embodiment, this has a thickness D of 0.35 mm and a thermal conductivity coefficient in the range between 1.1 W/mK and 1.90 W/mK.

The comparatively low thickness allows the selection of a more cost-effective paste-like, heat-conducting material. Not only is less paste-like, heat-conducting material required due to the lower thickness, but costs can also be saved by using a more cost-effective paste-like, heat-conducting material with a lower thermal conductivity coefficient.

The thickness D of the layer of paste-like, heat-conducting material as thermal paste is 0.35 mm in the embodiment. This is sufficient, since in particular the vertical play of the screw-on tabs 5 and the deviations in the shape of module 2 to module 2 can be compensated for by means of the sleeves 6.

The heat generated by the electrochemical cells is conducted from the module base 10 via the heat-conducting layer 9 into the base plate 11 of the housing 3. The base plate 11 of the housing 3 comprises, for example, a plurality of cooling channels 12, which are filled with a cooling medium, in particular cooling liquid, during operation and which absorb and dissipate the heat dissipated by the module 2.

In the end position E, the sleeve 6 is in contact with the screw-on tab 5 and the opening of the sleeve 6 is located directly above the opening of the screw-on tab 5. The annular end face of the sleeve 6, which is oriented towards the base plate 11, contacts the screw-on tab 5. The sleeve 6 thus provides shelter 8 for a section of the module 2 that radially limits the bore for the sleeve 6. The sleeve 6 thus protrudes downward beyond the boundary of the module 2. In this state, the sleeve 6 is fixed relative to the module 2 and also to the housing 3 by being welded to a part of the module 2 and to a part of the housing 3 by means of a weld seam 13.

Furthermore, in the end position E, module 2 is screwed to the screw-on tab 5 with a screw 7 guided through sleeve 6. The sleeve 6 supported on the screw-on tab 5 creates a hard screw connection, which ensures that module 2 is securely fixed to housing 3.

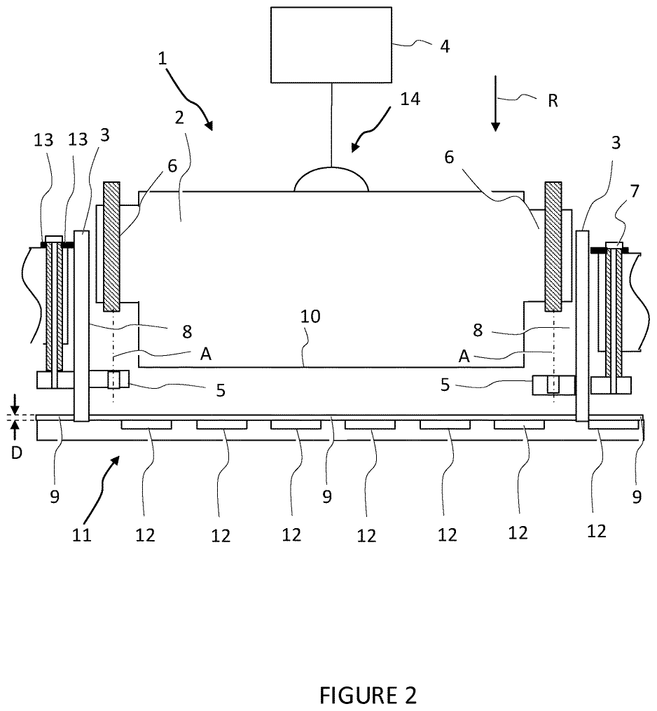

FIG. 2 shows module 2 not in an end position, but in a state during the positioning/arrangement of module 2 in housing 3 or during insertion into housing 3. Module 2 is arranged on a dome mount 14 and is rotatably mounted on this, in particular rotatably around an axis perpendicular to the blade plane. The dome mount 14 allows module 2 to be lowered into housing 3.

The dome-shaped holder 14 prevents the module base 10 from tilting relative to the base plate 11 when the module 2 is inserted, which is possible due to the deformation of the module base 10 and base plate 11. The rotatable bearing on the dome allows the module 2 and thus the module base 10 to follow the inclination of the base plate 11. When the module base 10 contacts a first section of the base plate 11, the force of the module base resting on the base plate exerts a torque on module 2 as it is lowered further, which aligns the position of the module with the position of the base plate 1. Furthermore, the calotte allows for a flat distribution of force and, as a result, reduces the bending moments acting on module 2 when module 2 is inserted into housing 3.

During insertion of module 2 into housing 3, the sleeves 6 are raised relative to their position in the end position so that they do not prevent the module from lowering onto layer 9 of the thermal paste. Only when module 2 is supported or placed on layer 9 are the sleeves 6 moved relative to module 2 in the direction of base plate 11 until they contact the screw-on tabs 5. For this purpose, the sleeves 6 have, for example, an oversized fit with respect to the bore of module 2.

Alternatively, the sleeves 6 may have a large shelter 8 so that, during the arrangement process of the module 2 in the housing 3, the sleeves 6 first contact the screw-on tabs 5 before the module base 10 rests on the layer 9. As module 2 is further lowered in a guided manner by means of the dome 14, the sleeves 6 are displaced upwards through the bore, i.e., in the opposite direction to the insertion direction R of module 2 into housing 3. This continues until the module base 10 rests on the base plate 11 or layer 9. This eliminates the need to move the sleeves 6 after the module 2 has been placed on the layer. In this case, it is advantageous if all sleeves have an identical shelter 8 before coming into contact with the screw-on tabs 5. For this purpose, the sleeves 6 have, for example, an oversized fit with regard to the borehole of the module 2.

Such an energy storage system makes it easier to deal with higher manufacturing inaccuracies. In particular, it allows for significant savings in paste-like, heat-conducting material and enables the use of more cost-effective paste-like, heat-conducting materials. The selectable layer thicknesses also depend on the manufacturing quality or manufacturing accuracy of the housing or frame. With excellent tolerances of the housing or frame and the bearing devices, the layer thickness can be limited to 0.3 mm and, if necessary, even less. Based on a current layer thickness of 2.5 mm, this results in a potential saving of approximately 88% in paste-like, heat-conducting material.

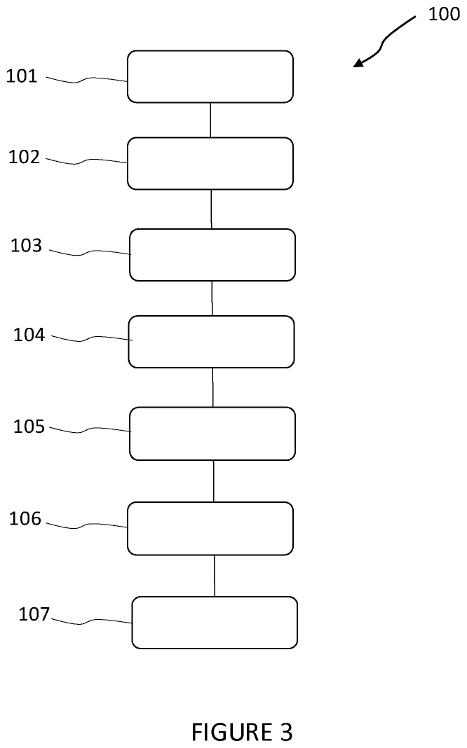

FIG. 3 shows a schematic process flow 100 for an embodiment of a method for manufacturing an embodiment of an energy storage device.

In a first process step 101, a flat layer of paste-like, heat-conducting material is applied to the base plate of the module, for example by means of a wide slot nozzle, or a bead is applied by means of a round nozzle. In the embodiment, a flat layer is applied. The application is carried out in such a way that the layer has an approximately uniform thickness of 0.35 mm in the final position. For the usual amounts of heat to be dissipated, a paste-like, heat-conducting material with a thermal conductivity coefficient of 1.5 W/mK to 1.9 W/mK can be selected. For increasing amounts of heat, a paste-like, heat-conducting material with higher thermal conductivity coefficients can also be used.

The area of the layer applied to the base plate should be matched to the area of the module base, or slightly larger than the area of the module base, so that the entire module base is in contact with the layer and good heat dissipation from the entire module base is possible.

Alternatively, the layer can be applied to the module base in such a way that the module base is essentially completely covered with the paste-like, heat-conducting material, with the layer having a substantially constant thickness of 0.35 mm. The layer is then inserted into the housing together with the module.

In a second process step 102, the module is attached to a cap for inserting or positioning or arranging the module in the housing. The cap is attached to a side of the module opposite the module base. Means other than a cap may also be used to arrange the module.

In a third process step 103, the module is lowered into the housing. A guide device designed as an automatic placement machine is used to lower the module into the housing in a controlled and regulated manner to the desired position of the module. Controlled and/or regulated insertion of the module can also be carried out on the basis of the contact pressure of the module on the base plate or layer. The sleeves enclosed by the module are arranged in a first elevated position. The guidance is such that the opening of the sleeves is lowered in alignment with the hole in the screw-on tabs, but the module does not contact the screw-on tabs.

During the lowering process, the sleeves also do not come into contact with the screw-on tabs due to their elevated position. This step is omitted if the module is inserted into the housing and the sleeves already have a clearance greater than the distance between the bearing device and the module in the sliding direction of the sleeves in the end position when the module is inserted.

In a fourth step 104, the module is placed and pressed onto the layer of pasty, heat-conducting material or the base plate. This ensures that the module base is in full contact with the pasty, heat-conducting material and that good heat conduction is achieved. The calotte can then be detached from the module. In this position, the module and the sleeves are still spaced apart from the storage device.

In a fifth process step 105, the sleeves are moved relative to the module in the direction of the base plate until they rest on or contact the screw-on tab.

In a sixth step 106, the sleeve is fixed to the module and/or the sleeve to the housing so that it is no longer movable relative to the housing or module. This can be done by welding or gluing. In the case of the sleeve, a semi-ring-shaped or ring-shaped weld seam around a part of the sleeve protruding upwards from the module, i.e., on a side of the module facing away from the screw-on tab, is suitable. However, other, possibly also detachable, fixing methods can also be used to secure the sleeve to the housing and/or module.

In a seventh step 107, the module is screwed to the screw-on tab, with the screw being inserted through the interior of the sleeve. Since the sleeve rests on the screw-on tab, a tight screw connection can be achieved and the module can be securely fastened to the housing.

The process is then repeated for the next module until the desired number of modules has been installed in the housing of the energy storage system.

What is claimed is:

1. An energy storage system, comprising:
a housing comprising at least one bearing device configured to secure the module;
at least one module configured to accommodate a plurality of electrochemical cells, wherein the at least one module is at least partially surrounded by the housing and arranged in an end position supported by the bearing device,
a contact element configured and arranged to transmit, in the end position, a force from the bearing device to the module, and
wherein, in the end position, the contact element is fixed in position with the housing and the module.

2. The energy storage system according to claim 1, wherein the contact element is configured as a sleeve enclosed by the module.

3. The energy storage system according to claim 1, wherein, in the end position, the module and the bearing device are additionally fixed to each other by means of a fastening element guided through the sleeve.

4. The energy storage system according to claim 2, wherein:
the sleeve comprises a shelter in an axial direction over a boundary of the module in the direction of the bearing device,
the bearing device is configured as a screw-on tab and the shelter is supported on the screw-on tab and the module and the screw-on tab are fastened relative to each other by means of a fastening element designed as a screw and guided through the sleeve.

5. The energy storage system according to claim 1, further comprising a layer of a paste-like, heat-conducting material arranged between a base of the module and a base plate of the housing, on which the module base is supported essentially over its entire surface, and wherein the base plate comprises at least one cooling channel in the region of the layer or below the module base, into which heat emitted by the module can be dissipated.

6. The energy storage system according to claim 5, wherein the layer of the paste-like, heat-conducting material comprises a thickness of 0.2 mm to 2.5 mm.

7. The energy storage system according to claim 5, wherein the paste-like, heat-conducting material comprises a thermal conductivity coefficient of 3.5 W/mK or less, or 2.5 W/mK to 1.0 W/mK.

8. The energy storage system according to claim 1, wherein:
the contact element is configured as a hollow-cylindrical sleeve enclosed by the module, and
a fastening element is guided through an interior of the sleeve and additionally fixes the module to the bearing device in the end position.

9. The energy storage system according to claim 1, wherein:
the module comprises at least one protruding guide element having a bore in which the sleeve is arranged, and
the guide element is configured to cooperate with a housing structure so as to guide the module into the end position.

10. The energy storage system according to claim 1, wherein:
the energy storage system comprises a plurality of modules, each module being at least partially surrounded by a respective housing portion provided with a bearing device on a side wall, and
the housing portions form partitions between adjacent modules.

11. A method for manufacturing an energy storage system with at least one module configured to accommodate a plurality of electrochemical cells, the method comprising the steps of:
applying a pasty heat-conducting material as a layer and/or a caterpillar to a base plate enclosed by a housing and/or to a module base,
arranging the module on the base plate such that a layer is located between the module and the base plate and/or a caterpillar is applied,
further arranging the module on the base plate and/or a bead such that a layer is arranged between the module and base plate, wherein, during the process of arranging the module the module is guided relative to the housing such that at least one contact element enclosed by the module or at least one sleeve, is aligned in its axial direction with at least one bearing device arranged on the housing;
wherein, during or after completion of the arrangement of the module, the at least one contact element is displaced in the axial direction relative to the module such that it contacts the aligned bearing device, and
wherein, after contacting the bearing device, the module with the at least one contact element and the at least one contact element are fixed relative to each other in the end position and are connected in a non-detachable manner, wherein the module is fixed to the at least one bearing device by means of a fastening means.

12. The method according to claim 11, wherein, the step of arranging the module on the base plate further comprises the steps of attaching the module to a calotte and arranging the module on the base plate with the calotte.

13. The method according to claim 11, further comprising the steps of:
welding the module to the sleeve;
welding the sleeve to the housing;
screwing the module to a bearing device configured as a screw-on bracket by means of a screw guided through the sleeve; and
configuring the bearing device as a screw-on tab.

14. The method according to claim 11, wherein:
the at least one contact element is configured as a hollow-cylindrical sleeve enclosed by the module, and
the fastening means is guided through an interior of the sleeve so as to additionally fix the module to the bearing device in the end position.

15. The method according to claim 11, wherein guiding the module relative to the housing comprises using at least one protruding guide element of the module having a bore in which the sleeve is arranged, and cooperating the guide element with a housing structure to guide the module into the end position.

16. The method according to claim 11, wherein, prior to displacing the at least one contact element in the axial direction, the method further comprises aligning the hollow-cylindrical sleeve with the bearing device arranged on a side wall of a housing portion that at least partially surrounds the module.

17. The method according to claim 11, wherein the method further comprises repeating the applying, arranging, guiding, displacing, fixing and fastening steps for a plurality of modules, each module being at least partially surrounded by a respective housing portion configured as a partition between adjacent modules.

18. The method according to claim 11, wherein applying the paste-like, heat-conducting material comprises applying a gap filler comprising a cross-linked silicone-based elastomer or a silicone-free gap filler to the base plate and/or the module base.

19. The method according to claim 11, wherein:
the paste-like, heat-conducting material is applied such that, after arranging the module, a layer having a thickness in a range from 0.25 mm to 1.0 mm is arranged between the module base and the base plate, and
the paste-like, heat-conducting material has a thermal conductivity coefficient in a range from 1.0 W/mK to 1.75 W/mK.

20. The method according to claim 11, wherein arranging the module on the base plate further comprises attaching the module to a calotte and arranging the module on the base plate with the calotte while the at least one contact element is aligned in its axial direction with the bearing device.
